(19) United States
(12) Patent Application Publication
(10) Pub. No.: US 2010/0238620 A1
(43) Pub. Date: Sep. 23, 2010

(54) Magnetic Notebooks and Tablets

(76) Inventor: Ram David Adva Fish, Menlo Park, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/730,194

(22) Filed: Mar. 23, 2010

Related U.S. Application Data
(60) Provisional application No. 61/210,821, filed on Mar. 23, 2009.

(51) Int. Cl. G06F 1/16

(52) U.S. Cl. 361/679.09; 361/679.29

(57) ABSTRACT

A computer system includes a base unit, a display unit detachable from the base unit, and a set of magnetic elements in the display unit and/or the base unit to attach the display unit to the base unit and to hold the display unit in the open position.

### RELATED APPLICATION

This application is related to and claims the benefit of U.S. Provisional Patent application Ser. No. 61/210,821 filed Mar. 23, 2009 which is hereby incorporated by reference.

### FIELD OF THE INVENTION

Embodiments of the present invention relate generally to computing devices, and more specifically to notebooks and tablets that utilize magnetic means for connection.

### BACKGROUND OF THE INVENTION

To enable consumers to easily interact with information and create documents, notebooks designs have traditionally required both a large display as well as a keyboard. Commonly, this has resulted in two separate physical parts, attached to each other with a mechanical hinge and cables. Such attachment means introduce additional complexity to the design of notebooks, add extra weight to notebooks, and do not provide flexibility in using the two parts of a notebook separately.

### BRIEF DESCRIPTION OF THE DRAWINGS

The present invention is illustrated by way of example, and not by way of limitation, and can be more fully understood with reference to the following detailed description when considered in connection with the figures in which:

FIG. 1 illustrates one embodiment of a computer system using a magnetic connection mechanism;

FIGS. 2A, 2B and 2C illustrate different combinations of a display unit and a base unit, in accordance with some embodiments of the invention;

FIGS. 3A and 3B illustrate alternative embodiments of an attachment mechanism for connecting a display unit with a base unit of a computer system;

FIG. 4 illustrates one embodiment for attaching a display unit to a base unit using a rotating rod;

FIGS. 5A and 5B illustrate alternative embodiments for attaching a display unit to a base unit using a magnetic flap mechanism;

FIGS. 6A and 6B illustrate alternative embodiments for attaching a display unit to a base unit using a notch mechanism; and

FIG. 7 is a block diagram of one embodiment of various internal components of a computer system such as a table or notebook computer system.

### DETAILED DESCRIPTION

Embodiments of the invention provide a computer system that includes a base unit and a display unit attachable to each other using a set of magnetic elements. The computer system may be a notebook, a netbook, a tablet, a portable computer or any other mobile device having a display unit and a base unit. The set of magnetic elements can be positioned in the display unit and/or the base unit to attach the display unit to the base unit and to hold the display unit in the open position. In one embodiment, the set of magnetic elements is also used as the sole means for keeping the display unit in the closed position.

Embodiments of the invention provide new ways to connect two separate parts of a computer system in a manner that gives the consumers more flexibility in using the computer system, provides better user experience, and reduces the mechanical complexity and the weight of the computer system.

In the following description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

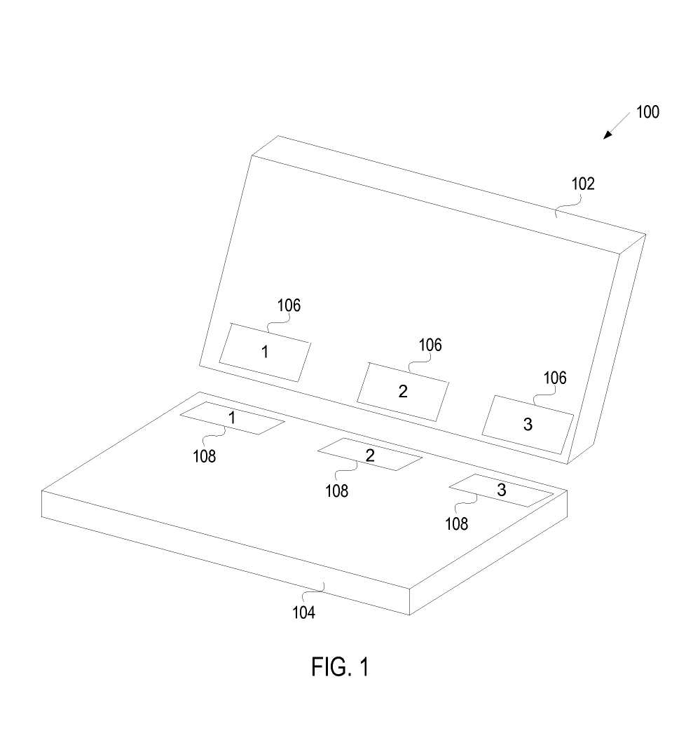

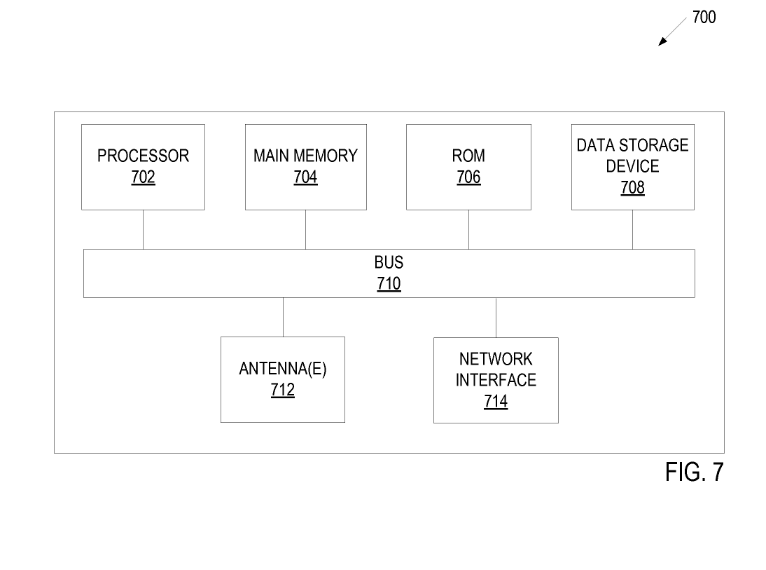

FIG. 1 illustrates one embodiment of a computer system 100 using a magnetic connection mechanism. The computer system 100 may be a notebook or tablet computer system or any other similar computer system. The computer system 100 includes a display unit 102 and a base unit 104. The display unit 102 may include a display device (e.g., a touch screen display device, etc.), a processor, a memory, a network interface and other components necessary to provide computer functionality. An exemplary display unit 102 will be discussed in more detail below in conjunction with FIG. 7.

The base unit 104 may be a fixed or semi-fixed base. It can be used solely as a mechanical base or also to provide additional function, such as charging the display unit 102 and/or expanding the electronic capabilities of the display unit 102 by incorporating into base unit 104 wired connectivity to networks (e.g., a telephone system, and/or a wired Ethernet), media connectivity (e.g., speakers, TV) and/or input devices connectivity (e.g., keyboard, additional touch areas, etc.). In one embodiment, the base unit 104 may be a keyboard with a full set of keys or a partial set of keys. The base unit 104 may include a microprocessor, an input device, and optionally other components to accomplish an intended functionality of the base unit 102 (e.g., a network interface, a cursor control device, etc.).

The display unit 102 includes a set of magnets 106, and the base unit includes a set of magnets 108. The number of magnets in each set may vary from 1 to several dozens, depending on the strengths and size of magnets and the size of the computer system 100. The number of magnets in both sets may be the same or different. As shown, all magnets may be positioned along the axis. Alternatively, other configurations are possible. In some embodiments, the magnets are included either in the base unit 104 or the display unit 102, as opposed to the configuration shown in FIG. 1. The set of magnets 106 and/or the set of magnets 108 attach the display unit 102 to the base unit 104 and hold the display unit 102 in the open position. In one embodiment, the set of magnets 106 and/or the set of magnets 108 are also used as the sole means for keeping the display unit 102 in the closed position.

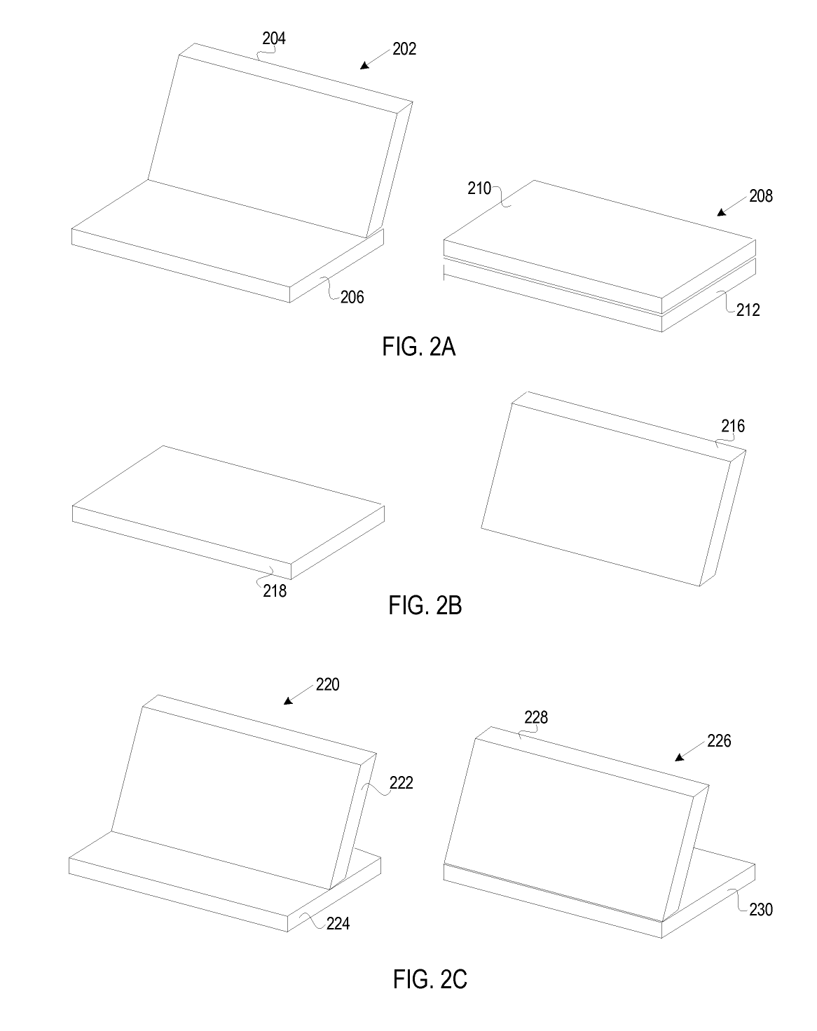

FIGS. 2A, 2B and 2C illustrate different combinations of a display unit and a base unit, in accordance with some embodiments of the invention. Referring to FIG. 2A, a computer system 202 includes a base unit 206 and a display unit 204 attached to the base unit 206, where the back of the display unit 204 is aligned with the back of the base unit 206. The display unit 204 is attached to the base unit 206 and is kept in the open position using magnets. The computer system 208 includes a base unit 206 and a display unit 204 attached to each other using the magnets and kept in the closed position using the magnets.

Referring to FIG. 2B, a base unit 218 and a display unit 216 are shown as independent components not attached to each other. Referring to FIG. 2C, a computer system 220 includes a base unit 224 and a display unit 222 attached to the middle of the top surface of the base unit 222 using magnets. The display unit 222 is kept in the open position using magnets. A computer system 226 includes a base unit 230 and a display unit 228 attached to the base unit 230, where the front of the display unit 228 is aligned with the front of the base unit 230. The display unit 228 is attached to the base unit 230 and is kept in the open position using magnets.

Various other combinations of a display unit and a base unit are possible. In addition, a single base unit may be used with multiple display units attached to different portions of the base unit.

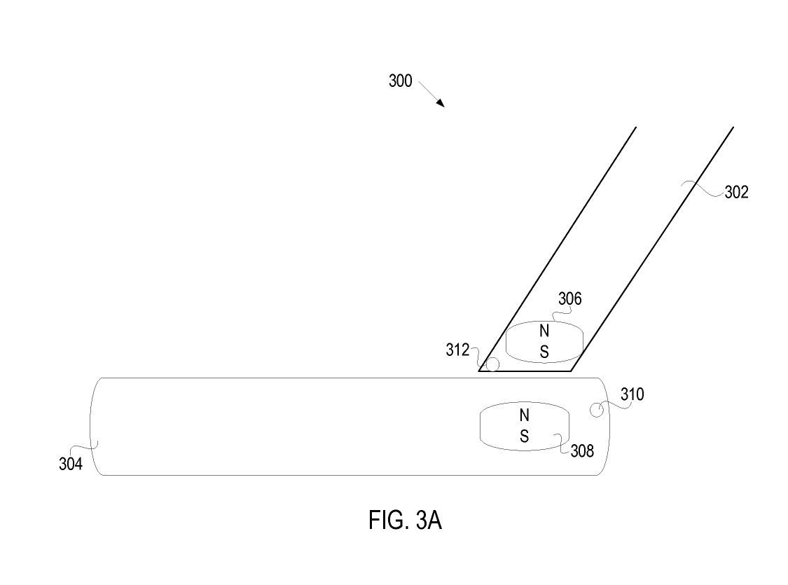

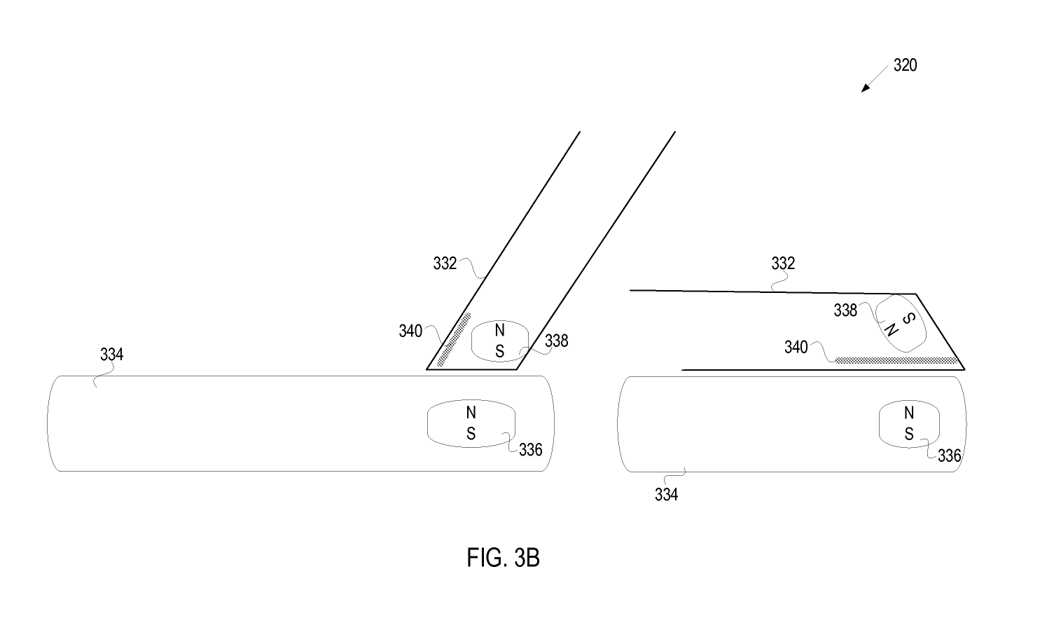

FIG. 3A illustrates one embodiment of an attachment mechanism 300 for connecting a display unit 302 with a base unit 304 of a computer system. The display unit 302 includes one or more magnets 306 (e.g., along the X axes), and the base unit 304 includes one or more magnets 308 (e.g., along the X axes) to attach the display unit 302 to the base unit 304. Depending on the strength of the magnets, it might be sufficient to place only magnets 306 or 308 in either unit 302 or 304, as opposed to both units 302 and 304.

In one embodiment, a sensor 312 is included in the display unit 302 to detect when and which base unit 304 the display unit 302 is connected to and to adopt the user interface or applications of the display unit 302 to the specific base.

The base unit 304 may communicate with the display unit 302 using a wireless communication means (e.g., WiFi, Bluetooth, etc.). Other signals between the base unit 304 and the display unit 302 can be transmitted using physical connectors or different short range wireless signals. Power between the two units can be transferred using physical connectors or other wireless methods such as inductive charging. In one embodiment, a magnetic sensor 310 is included in the keyboard 304 to detect proximity to the display unit 302 and commence signaling (e.g., using electro-magnet or RF mechanism) the ID of the keyboard or another indication that the keyboard mode should be operated. This can allow the keyboard to conserve power or the user to have multiple keyboards each associated with one or more specific display.

FIG. 3B illustrates one embodiment of an attachment mechanism 320 for connecting a display unit 332 with a base unit 334 using ferromagnetic material. The display unit 332 includes one or more magnets 338 (e.g., along the X axes), and the base unit 334 includes one or more magnets 336 (e.g., along the X axes) to attach the display unit 332 to the base unit 334. The magnets 336 and 338 are used to keep the display unit 332 in the open position. When the display unit is closed, the magnets 336 are attracting ferromagnetic material 340 to keep the device in the closed position.

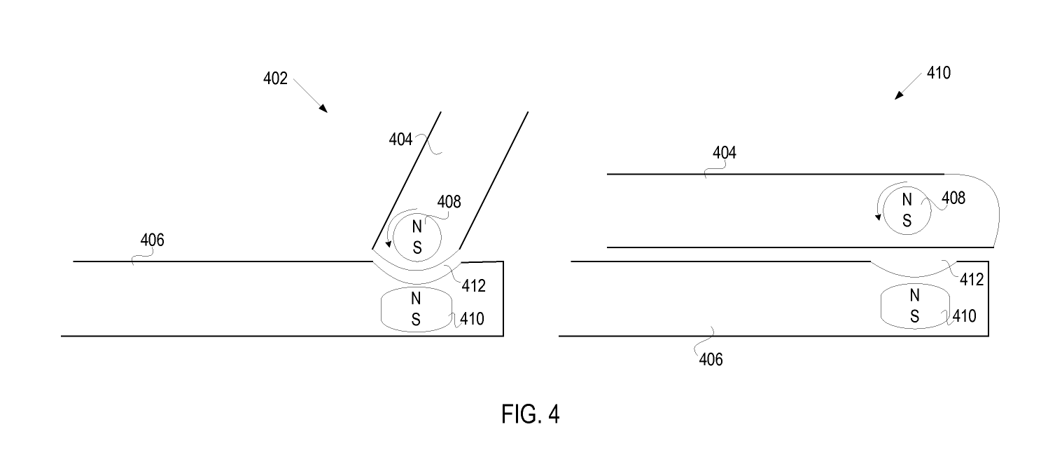

FIG. 4 illustrates one embodiment for attaching a display unit 404 to a base unit 406 using a rotating rod. The display unit 404 includes one or more magnets 408, and the base unit 406 includes one or more magnets 410. As shown, the magnetic element 408 is mounted on a rotating rod(s). The rotating rod allows the angle for attaching the display unit 404 to be adjusted to ensure that the magnets are directed in the right (desired) direction in both closed position 402 and open position 410 of the device.

In one embodiment, in the open position, the base unit 406 has a circular notch 412 to ensure that the display unit 404 can be mounted at different angles. While the magnets are used to apply force pulling the display unit 404 toward the base unit 406, preventing rotation of the display unit can be accomplished by placing special grooves, notches or frictional material in the notch 512 and the area of the display unit 404 that touches the base unit 406 or vice versa.

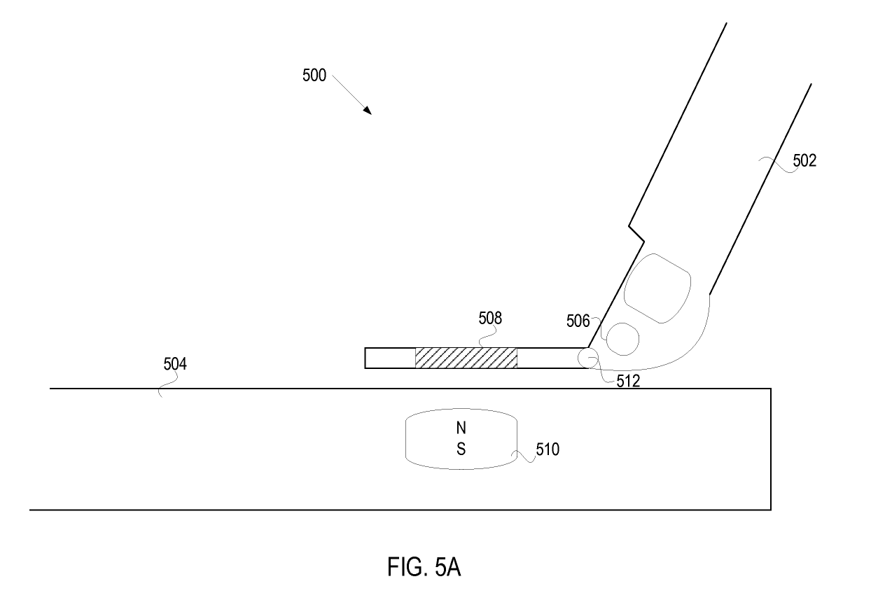

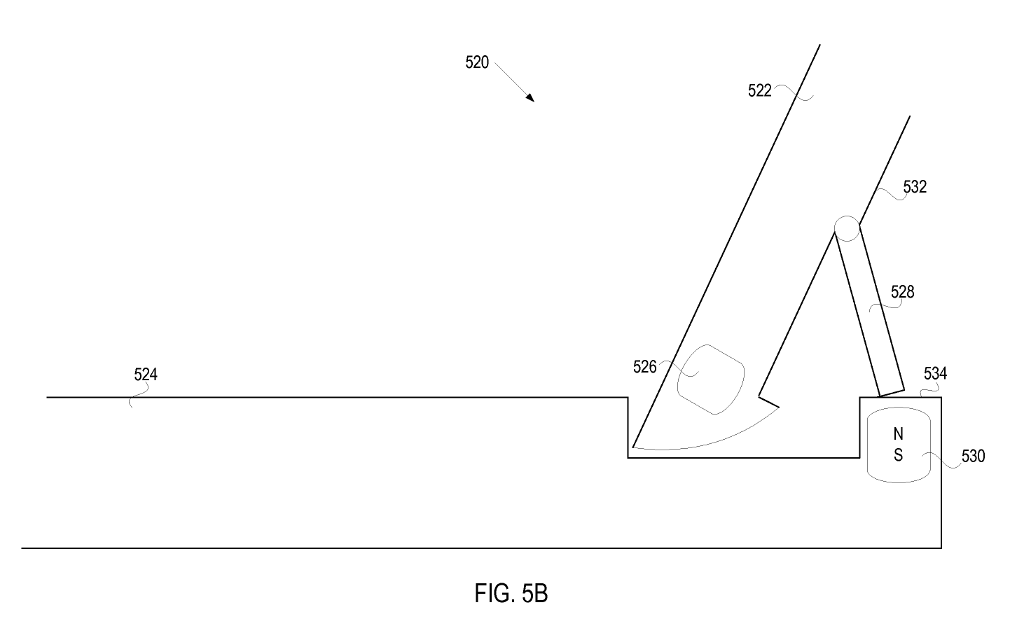

FIG. 5A illustrates one embodiment for attaching a display unit 502 to a base unit 504 using a magnetic flap mechanism. In particular, a computer system 500 includes a retractable flap 508 that can be extended from the display unit 502 either manually or once the proximity to the base unit 504 is detected through the electromagnetic force applied by an electromagnet 506. Once extended, flap 508 is attracted to magnet 510 in the base unit 504. The advantage of this method is that because the force is applied further away from the torque point/hinge 512, the stability of the display unit 502 is enhanced.

FIG. 5B illustrates an alternative embodiment for attaching a display unit 522 to a base unit 524 using a magnetic flap mechanism. In particular, a computer system 520 includes a retractable flap 528 that can be extended from the base unit 524 either manually or once the proximity to the base unit 524 is detected and an electromagnetic force applied by an electromagnet 526. Once extended, flap 528 is attracted to magnet 530 in the base unit 524. The advantage of this method is that because the force the flap angle can be adjusted so that the overall angle of the display unit can vary. This is done by placing friction or grooves on the surface area 534 where the flap 528 is touching the base unit 524.

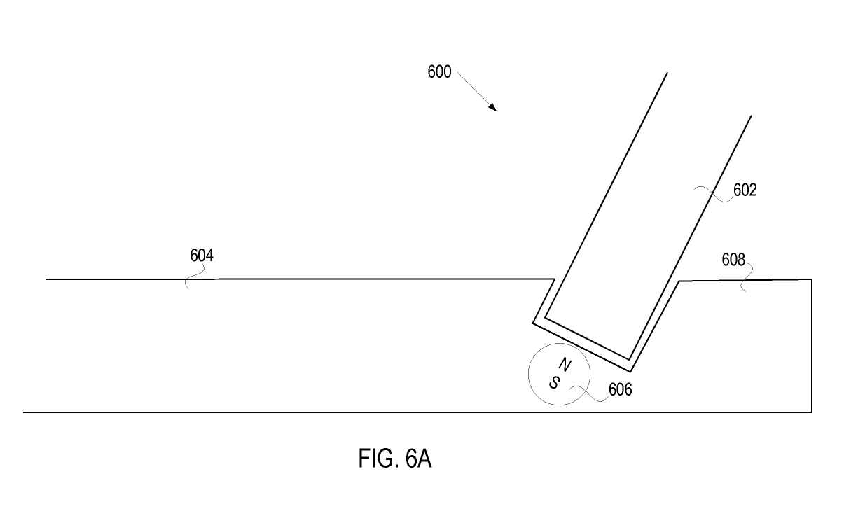

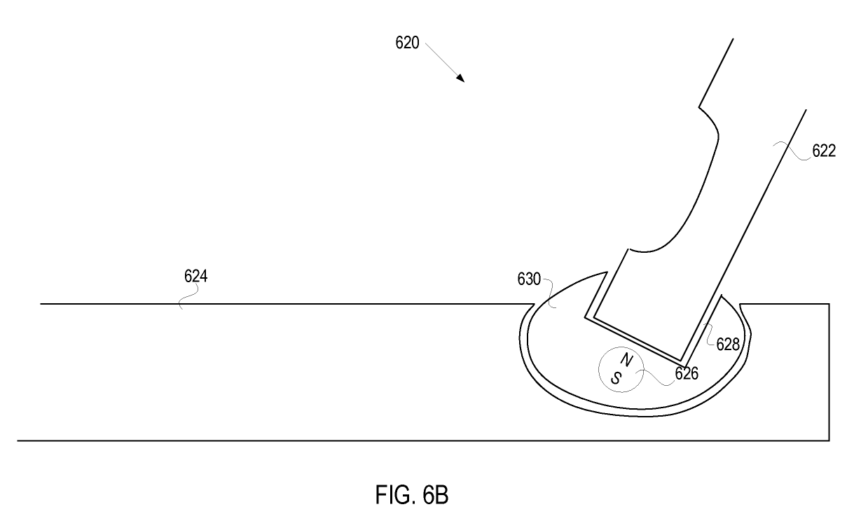

FIG. 6A illustrates one embodiment for attaching a display unit 602 to a base unit 604 using a notch mechanism. In particular, in a computer system 600 the base unit 604 has a notch 608 allowing the display unit 602 to be inserted into the notch 608. A magnet 606 is also used to further pull the units 602 and 604 together and create more stability for the attachment.

FIG. 6B illustrates an alternative embodiment for attaching a display unit 622 to a base unit 624 using a notch mechanism. In particular, a computer system 620 includes a circular bar 630 placed inside the base unit 624 to allow rotation. The circular 630 bar has a notch 628 where the base display unit 622 can be inserted. The advantage of this method is that the angle of the display unit 622 can be adjusted. Again, a magnet 626 can be used to pull the display unit 622 toward the base unit 624. In one embodiment, different electrical, magnetic or electromagnetic mechanisms can be used to lock the rod in a specific angle.

FIG. 7 is a block diagram of one embodiment of various internal components of computer system 700 such as a table or notebook computer system. For purposes of illustration and ease of explanation, computer system 700 includes the components described below. However, other embodiments of computer system 700 can include more, fewer and/or different components.

Computer system 700 includes a bus 710 or other communication device to communicate information, and processor 720 coupled to bus 710 to process information. While computer system 700 is illustrated with a single processor, computer system 700 can include multiple processors and/or co-processors.

Computer system 700 further includes random access memory (RAM) or other dynamic storage device 730 (referred to as memory), coupled to bus 710 to store information and instructions to be executed by processor 720. Memory 730 also can be used to store temporary variables or other intermediate information while processor 720 is executing instructions. Computer system 700 also includes read-only memory (ROM) and/or other static storage device 740 coupled to bus 710 to store static information and instructions for processor 720, such as touch screen recognition software.

In addition, data storage device 750 is coupled to bus 710 to store information and instructions. Data storage device 750 may comprise a magnetic disk (e.g., a hard disk), optical disc (e.g., a CD-ROM) and/or digital versatile disc (DVD), and corresponding drive. Computer system 700 may further include one or more antennae 760 and/or network interface 770, to provide via, for example, wireless connection access to a network, such as a personal area network, local area network and/or wide area network.

Instructions are provided to memory from a machine-accessible medium, or an external storage device accessible via a remote connection (e.g., over a network via antenna 760 and/or network interface 770) providing access to one or more electronically-accessible media, etc. A machine-accessible medium includes any mechanism that provides (i.e., stores and/or transmits) information in a form readable by a machine (e.g., a computer). For example, a machine-accessible medium includes RAM; ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions in embodiments of the present invention. Thus, the embodiments of the present invention are not limited to any specific combination of hardware circuitry and software instructions.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer system comprising:
a base unit;
a display unit detachable from the base unit, the display unit comprising a display device, a processor and a memory; and
a set of magnetic elements in at least one of the display and base units to attach the display unit to the base unit and to hold the display unit in an open position.

2. The system of claim 2 wherein the first unit comprises a sensor to detect proximity of the display unit to the base unit, and to cause the display unit to operate in a specific mode.

3. The system of claim 1 wherein the display unit further comprises a ferramagnetic material to keep the display unit in a closed position.

4. The system of claim 1 further comprising at least one rotating rod having mounted thereon one or more magnetic elements from the set, the rotating rod making an angle of the display unit adjustable to ensure that the magnetic elements are directed in an desirable direction.

5. The system of claim 4 wherein the base unit comprises a circular notch to adjust an angle for mounting the display unit.

6. The system of claim 1 further comprising a retractable flap extendable from the base unit.

7. The system of claim 1 wherein the base unit comprises a notch in the base unit for inserting the display unit.

8. The system of claim 1 wherein the base unit is at least one of a keyboard unit or a charging unit.

9. A computer system comprising:
a base unit;
a display unit detachable from the base unit, the display unit a display device, a processor and a memory; and
a set of magnetic elements in at least one of the display and base units to attach the display unit to the base unit when the display unit is in a closed position, wherein the set of magnetic elements is a sole means for keeping the display unit and the base unit together when the display unit is in the closed position.
